(19) United States
(12) Patent Application Publication
(10) Pub. No.: US 2025/0023338 A1
(43) Pub. Date: Jan. 16, 2025

(54) Cable Joint

(71) Applicant: HSP HOCHSPANNUNGSGERÄTE GMBH, Troisdorf (DE)

(72) Inventor: Achim Langens, Lohmar (DE)

(21) Appl. No.: 18/714,847

(22) PCT Filed: Nov. 30, 2021
(86) PCT No.: PCT/EP2021/083545

§ 371 Date: Jul. 31, 2024

(51) Int. Cl. H02G 15/103

(52) U.S. Cl. CPC H02G 15/103

(57) ABSTRACT

The invention relates to a cable joint (1) for connecting two current conductor portions for conducting a direct current, comprising a control body (3) and a conductive connection piece (2) which is surrounded by the control body, wherein the connection piece has a first receptacle and a second receptacle, so that a conductor end of a first current conductor portion can be inserted into the first receptacle in order to establish an electrical contact between the connection piece and the conductor end of the first current conductor portion, and a conductor end of a second current conductor portion can be inserted into the second receptacle in order to establish an electrical contact between the connection piece and the conductor end of the second current conductor portion, and wherein the control body comprises insulation-spaced, concentric, conductive control inserts (11-17) for resistive field control.

The invention relates to a cable joint.

Cable joints are known in low-voltage technology as branch points and connection sleeves for electrical installations. In high-voltage technology (configured for operating voltages above 300 kV), cable connections have much higher demands in terms of insulation and field load. In addition, it is known that in particular high-voltage cables are limited in length for production-related reasons. Particularly long connections of electrical lines occur in high-voltage direct current transmission.

The object of the invention is that of proposing a cable joint which allows reliable high-voltage direct current transmission over long cable distances.

The object is achieved by a cable joint for connecting two current conductor portions for conducting a direct current, comprising a control body and a conductive connection piece which is surrounded longitudinally by the control body, wherein the connection piece has a first receptacle and a second receptacle, so that a conductor end of a first current conductor portion can be inserted into the first receptacle in order to establish an electrical contact between the connection piece and the conductor end of the first current conductor portion, and a conductor end of a second current conductor portion can be inserted into the second receptacle in order to establish an electrical contact between the connection piece and the conductor end of the second current conductor portion, and wherein the control body comprises insulation-spaced, substantially or virtually concentric, conductive control inserts (e.g. made of aluminum foil) for resistive field control.

The cable joint is configured for direct current applications. A substantial difference between a cable joint for alternating current applications and the cable joint for direct current applications is the manner of the field control, i.e. the control of the field distribution in the region of the cable connection or of the connection piece. The field control appropriately requires the most uniform possible field distribution between the current-carrying conductor and earth (i.e. essentially the outside surroundings). This is expediently achieved in that the respective impedances between the control inserts are as identical as possible. In this case, in the case of alternating current, the capacitance between the control inserts is decisive, while in the case of direct current the resistive fraction of the impedance between the control inserts prevails. This requires difference spacings of the control inserts for alternating or direct current applications. Preferably, when determining the spacings between the control insert, a compromise or an optimum between purely resistive and capacitive/resistive control is determined, particularly in applications in which direct current having an alternating current portion is present. It is furthermore also conceivable to select the spacing of the control inserts in such a way that it increases or also reduces, outwards (depending on the respective temperature dependency of the resistance of the insulation material used). In this way, the temperature effect of the operating temperature, which reduces with distance from the current conductor, can be taken into account. In particular, the control inserts are insulation-spaced, i.e. separated from one another by layers of insulation. The layers of insulation can be made of a suitable insulating material such as paper, cardboard, synthetic materials, non-woven fabric, or the like. The invention advantageously makes possible longer transmission distances since it allows a reliable connection of the current conductor portions to one another. The inserted control inserts result in a resistive (or resistive/capacitive), linear voltage distribution and an optimal design and utilization of the dielectric of the control body, which provides said reliability of the power connection. The cable joint according to the invention furthermore has the advantage that it can be configured for a reversible connection of the current conductor portions, i.e. can be released again in the event of a necessary replacement.

In order to improve the electrical insulation capacity, the control body is preferably impregnated with a resin, in particular an epoxy resin.

In view of its usability in high-voltage direct current transmission systems, the control body has a dielectric strength of at least 320 kV. This can be achieved for example by corresponding dimensioning of the control body.

According to a variant, the connection piece is configured for establishing a detachable connection by means of a press fit, in each case to the first and the second conductor end.

The cable joint preferably comprises a charge carrier arrester, made of an electrically conductive material, which is electrically connected to an outermost control insert and is configured for discharging surface charge carriers. During operation of the cable joint under DC voltage, charge carriers form on the surface of the control body. Said charge carriers can cause undesired flashovers. The charge carrier arrester, which can be applied to the control body or a strip of an insulator material for example by painting on, serves to discharge said surface charge carriers.

In a suitable manner, a fastening flange is provided on the outside, on the control body, which fastening flange is configured for connection to a retaining device of the first current conductor portion. In this way, the connection is mechanically reinforced, and furthermore the cable end is prevented from slipping out of the cable joint (for example when high axial tensile forces are applied).

According to an embodiment of the invention, the first and second opening are in each case cone-shaped and are arranged such that the conductor end of the first current conductor portion is guided through the first opening in order to establish electrical contact between the connection piece and the conductor end of the first current conductor portion, and the conductor end of the second current conductor portion is guided through the second opening in order to establish electrical contact between the connection piece and the conductor end of the second current conductor portion. Accordingly, the cable joint has an inner cone at each end, into which cone the respective cable end can be inserted. For dielectric reinforcement, an intermediate space between the cable end and the inner cone can be filled with a flexible insulating material, for example silicone.

The invention will be explained in further detail in the following, with reference to embodiments shown in the figures.

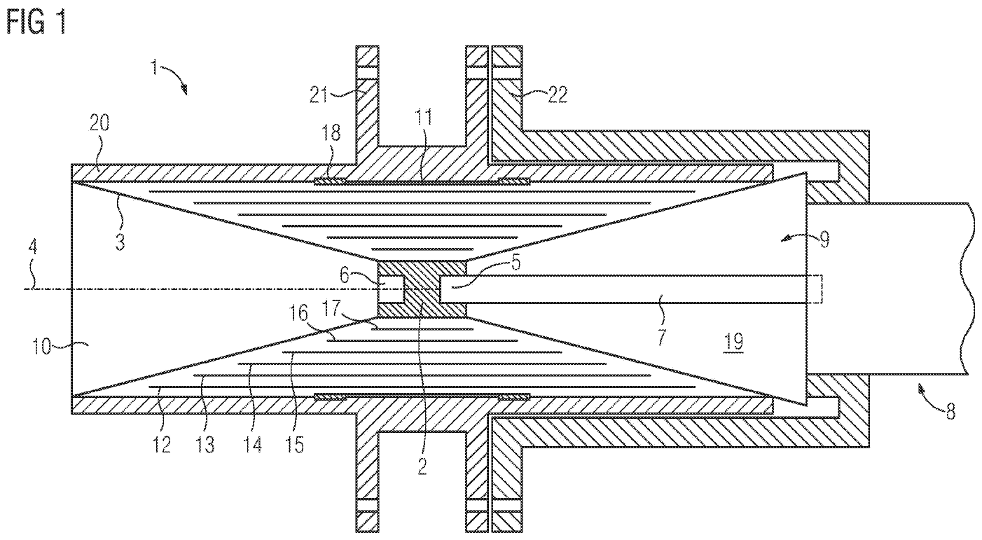

FIG. 1 is a schematic view of a first embodiment of a cable joint according to the invention;

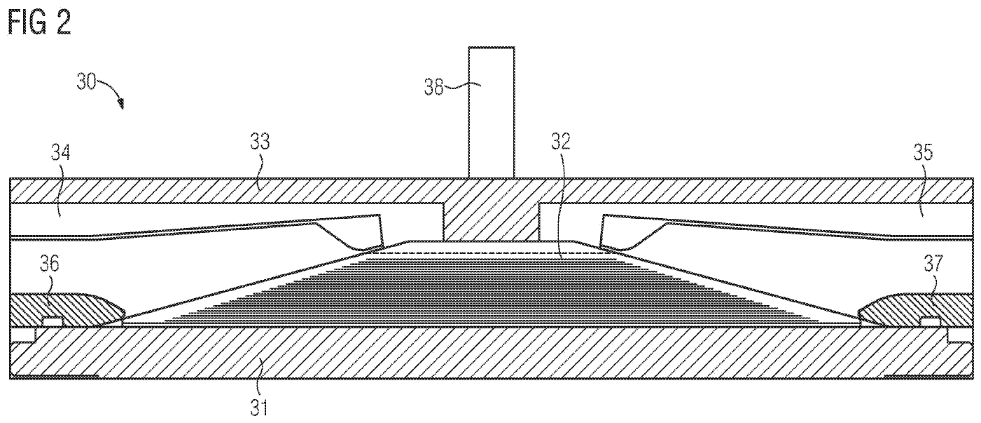

FIG. 2 is a schematic view of a second embodiment of a cable joint according to the invention.

FIG. 1 shows a cable joint 1 for connecting two current conductor portions. The cable joint 1 comprises a connection piece 2, which is surrounded longitudinally by a control body 3. A dashed line 4 indicates a central axis of the assembly, which is also understood to be the longitudinal direction of the cable joint. The connection piece 2 comprises a first receptacle 5 and a second receptacle 6. A conductor end 7 of a cable 8 can be guided through a cone-shaped first opening 9 in the control body 2 and guided into the first receptacle 5, such that electrical contact between the conductor end 7 and the connection piece 2 is established. For assisting the contacting, the receptacles 5, 6 can comprise a suitable contact system, for example inner ribs or the like. An intermediate space 19 between the conductor end 7 and the control body 3 is filled with a silicone material 19. In order to establish electrical contact with a second conductor end of a second cable, a second cone-shaped opening 10 in the control body and the second receptacle 6 are provided. The connection piece comprises a conductive material, e.g. copper or aluminum.

The control body 3 is arranged concentrically around the connection piece 2. The control body 3 comprises concentric control inserts 11 to 17 for electrical field control. In the example shown, the control inserts 11-17 are configured as aluminum foils. The control inserts are spaced apart from one another by insulating layers. In the example shown, the insulating layers comprise resin-impregnated paper.

A charge carrier arrester 18 is arranged on the outside, on the control body 3, which arrester is electrically connected to the outermost control insert 11. Surface charge carriers, which result during direct current operation, are discharged to earth by means of the charge carrier arrester 18.

The cable joint 1 further comprises a housing 20 and a fastening flange 21. During operation of the cable joint 1, the fastening flange 21 is mechanically connected to a retaining device 22 of the cable portion 8.

FIG. 2 shows a cable joint 30. The cable joint 30 comprises a connection piece 31, which is surrounded longitudinally by a control body 32. The design of the control body 32 substantially corresponds to the design of the control body 3 of the cable joint 1 of FIG. 1, comprising insulation-spaced control inserts. In contrast with the embodiment of FIG. 1, the control body 32 comprises axially outwardly tapering cone-shaped ends on both sides. An intermediate space 34 and 35, respectively, is located in each case between a housing 33 of the cable joint 30 and the control body 32, on both sides of the cable joint 30. The intermediate spaces 34, 35 serve in each case as receptacles for fastening elements of cable ends 36 and 37, respectively, to be connected. For dielectric reinforcement, furthermore a flexible insulation material that surrounds the cable ends 36, 37 can be provided in the intermediate space. A fastening flange 38 on the outside of the housing 33 has a corresponding function to the fastening flange 21 of the cable joint 1 from FIG. 1.

1. Cable joint (1) for connecting two current conductor portions for conducting a direct current, comprising
a control body (3) and
a conductive connection piece (2) which is surrounded by the control body (3), wherein the connection piece (2) comprises a first receptacle (5) and a second receptacle (6), so that a conductor end (7) of a first current conductor portion (8) can be inserted into the first receptacle (5) in order to establish an electrical contact between the connection piece (2) and the conductor end (7) of the first current conductor portion (8), and a conductor end of a second current conductor portion can be inserted into the second receptacle (6) in order to establish an electrical contact between the connection piece (2) and the conductor end of the second current conductor portion, and wherein
the control body (3) comprises insulation-spaced, concentric, conductive control inserts (11-17) for resistive field control.

2. Cable joint (1) according to any one of the preceding claims, wherein the control body (3) is resin-impregnated.

3. Cable joint according to any one of the preceding claims, wherein the control body (3) has a dielectric strength of at least 320 kV.

4. Cable joint (1) according to any one of the preceding claims, wherein the connection piece (2) is configured for establishing a detachable connection by means of a press fit, in each case to the first and the second conductor end.

5. Cable joint (1) according to any one of the preceding claims, wherein the cable joint (1) further comprises a charge carrier arrester (18) which is electrically connected to an outermost control insert (11) and is configured for discharging surface charge carriers.

6. Cable joint (1) according to any one of the preceding claims, wherein a fastening flange (21) is provided on the outside, on the control body (3), which fastening flange is configured for connection to a retaining device (22) of the first current conductor portion (8).

7. Cable joint (1) according to any one of the preceding claims, wherein the control body (3) comprises a first and a second opening (9, 10), and the first and second opening (9, 10) are in each case cone-shaped and are arranged such that the conductor end (7) of the first current conductor portion (8) is guided through the first opening (9) in order to establish electrical contact between the connection piece (2) and the conductor end (7) of the first current conductor portion, and the conductor end of the second current conductor portion is guided through the second opening (10) in order to establish electrical contact between the connection piece (2) and the conductor end of the second current conductor portion.

8. High-voltage line system for conducting a direct current, comprising a first and a second cable, wherein the two cables are mechanically and electrically interconnected by means of a cable joint according to any one of claims 1 to 7.
